(19) United States
(12) Patent Application Publication
(10) Pub. No.: US 2021/0224476 A1
(43) Pub. Date: Jul. 22, 2021

(54) METHOD AND APPARATUS FOR DESCRIBING IMAGE, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Zhen WANG, Beijing (CN); Tao LIU, Beijing (CN)

(21) Appl. No.: 17/034,310

(22) Filed: Sep. 28, 2020

(30) Foreign Application Priority Data
Jan. 20, 2020 (CN) 202010065500.9

(51) Int. Cl. G06F 40/274; G06K 9/46; G06K 9/62; G06F 40/186

(52) U.S. Cl. CPC G06F 40/274; G06F 40/186; G06K 9/6232; G06K 9/4671

(57) ABSTRACT

The present disclosure discloses a method for describing an image, an electronic device and a storage medium. A target image is acquired. Recognition is performed on the target image through N image recognition models to generate M basic features of the target image. M basic feature labels are generated based on the M basic features. An image description sentence of the target image is generated based on the M basic feature labels.

### CROSS REFERENCE TO RELATED APPLICATIONS

This application claims priority and benefits of Chinese Application No. 202010065500.9, filed on Jan. 20, 2020, the entire content of which is incorporated herein by reference.

### FIELD

The present disclosure relates to the field of image processing technologies, in detail, to the field of computer visual technologies, and more particularly, to a method and apparatus for describing an image, an electronic device and a storage medium.

### BACKGROUND

Image description aims at automatically generating a descriptive text for an image, i.e., expressing the image in language. The process of image description requires detecting objects in an image, understanding the relationships among the objects, and expressing the relationships properly.

### SUMMARY

Embodiments of the present disclosure provide a method for describing an image, including: acquiring a target image; performing recognition on the target image through N image recognition models to generate M basic features of the target image, in which N is a positive integer, and M is a positive integer less than or equal to N; generating M basic feature labels based on the M basic features; and generating an image description sentence of the target image based on the M basic feature labels.

Embodiments of the present disclosure provide an electronic device including at least one processor and a storage device communicatively connected to the at least one processor. The storage device stores an instruction executable by the at least one processor. When the instruction is executed by the at least one processor, the at least one processor may implement the method for describing an image described above.

Embodiments of the present disclosure provide a non-transitory computer-readable storage medium having a computer instruction stored thereon. The computer instruction is configured to make a computer implement the method for describing an image described above.

Other effects of the above-mentioned optional implementations will be described below in combination with specific embodiments.

### BRIEF DESCRIPTION OF THE DRAWINGS

The accompanying drawings are used for a better understanding of the solution, and do not constitute a limitation to the present disclosure.

FIG. 1 is a schematic diagram according to Embodiment 1 of the present disclosure.

FIG. 2 is a schematic diagram according to Embodiment 2 of the present disclosure.

FIG. 3 is a schematic diagram according to Embodiment 3 of the present disclosure.

FIG. 4 is a schematic diagram according to Embodiment 4 of the present disclosure.

FIG. 5 is a block diagram of an electronic device for implementing a method for describing an image according to embodiments of the present disclosure.

FIG. 6 is a schematic diagram according to Embodiment 5 of the present disclosure.

### DETAILED DESCRIPTION

Exemplary embodiments of the present disclosure are described below with reference to the accompanying drawings, which include various details of the embodiments of the present disclosure to facilitate understanding, and should be considered as merely exemplary. Therefore, those skilled in the art should recognize that various changes and modifications may be made to the embodiments described herein without departing from the scope and spirit of the present disclosure. Also, for clarity and conciseness, descriptions of well-known functions and structures are omitted in the following description.

In the related art, a single recognition model is usually used to recognize an image, and a feature label is generated based on a single feature of the recognized image to describe the image. Such a method in the related art has the technical defect that little information is recognized from the image, and the generated feature label cannot fully express information in the image. With respect to the technical defect, embodiments of the present disclosure provide a method for describing an image.

With the method for describing an image, the recognition is performed on the target image acquired through a plurality of image recognition models to generate a plurality of basic features of the target image. A plurality of basic feature labels are generated based on the plurality of basic features. An image description sentence of the target image is generated based on the plurality of basic feature labels. With the above method, the image description sentence generated is more expressive, information in the target image may be fully expressed, and the accuracy and reliability of the image description sentence are improved.

Hereinafter, a method and apparatus for describing an image, an electronic device and a computer-readable storage medium according to embodiments of the present disclosure are described with reference to the accompanying drawings.

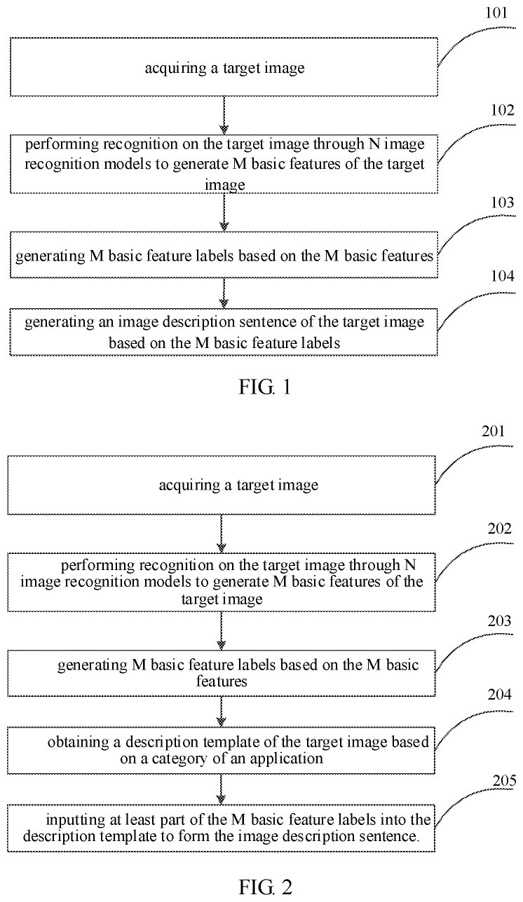

The method for describing the image according to embodiments of the present disclosure will be described in detail below with reference to FIG. 1.

FIG. 1 is a schematic diagram according to Embodiment 1 of the present disclosure.

As illustrated in FIG. 1, the method for describing the image provided by the present disclosure may include the following steps.

At block 101, a target image is acquired.

In detail, the method for describing the image according to embodiments of the present disclosure may be implemented by the apparatus for describing the image according to embodiments of the present disclosure. The apparatus may be configured in an electronic device to generate an image description sentence of the target image, such that the description of the image is realized. The electronic device may be any hardware device capable of image processing, such as a smart phone, a notebook computer, a wearable device, and so on.

The target image may be any type of image to be image processed, such as a static image, a dynamic image, and a frame of image in a video, which is not limited in the present disclosure.

At block 102, recognition is performed on the target image through N image recognition models to generate M basic features of the target image.

N is a positive integer, and M is a positive integer less than or equal to N.

In embodiments of the present disclosure, the image recognition model includes more than one of a face recognition model, a text recognition model, a classification recognition model, a logo recognition model, a watermark recognition model, a dish recognition model, a license plate recognition model, a facial expression recognition model, an age recognition model, and a skin color recognition model that implement different functions.

A basic feature is a feature generated by one image recognition model through recognizing the target image. For example, the face recognition model recognizes the target image to generate a face feature; the facial expression recognition model recognizes the target image to generate a facial expression feature; and so on.

It may be understood that since each basic feature is generated by recognizing the target image through one image recognition model, each basic feature may individually present certain kind of information of the image. For example, the face feature generated by using the face recognition model to recognize the target image may show face information such as the five sense organs and a contour. The facial expression feature generated by using the facial expression recognition model to recognize the target image may present facial expression information such as smiling and crying.

In detail, after the target image is acquired, the recognition may be performed on the target image through the N image recognition models to generate the M features of the target image. Since not all image recognition models may obtain a recognition result, M is a positive integer less than or equal to N.

It should be noted that when the target image is recognized through the N image recognition models, the number of N may be set as needed. For example, the target image may be processed by all the image recognition models available for the apparatus for describing the image, or by some of the image recognition models, such as the face recognition model, the text recognition model, and the classification recognition model, according to the embodiments of the present disclosure.

The process of performing the recognition on the target image through the image recognition model may be referred to a method of recognizing an image to generate features of the image in the related art, which will not be repeated herein. For example, if the face recognition model is a pre-trained neural network model, the target image may be inputted into the neural network model to obtain the face feature of the target image.

At block 103, M basic feature labels are generated based on the M basic features.

In an exemplary embodiment, the M basic features may be respectively input to a label generation model for label extraction, and then M corresponding image feature labels may be generated respectively.

For example, suppose that for an image of a four- or five-year-old girl smiling, a face feature, an age feature, and a facial expression feature of the image are recognized through the face recognition model, the age recognition model, and the facial expression recognition model. The face feature may be inputted into the label generation model to generate a basic feature label “girl”, the age feature may be inputted into the label generation model to generate a basic feature label “four or five years old”, and the facial expression feature may be inputted into the label generation model to generate a basic feature label “smiling” or “happy”.

The label generation model may be any model that may process image features to generate corresponding feature labels, such as a neural network model including a convolutional neural network and a recurrent neural network, and other models. The label generation model is not limited in the present disclosure. The present disclosure takes the label generation model being a neural network model as an example for description.

In detail, the label generation model may be trained based on a large number of training images that have been labeled with image feature labels. In detail, when the label generation model is trained, the N image recognition models may be adopted to recognize the M basic features corresponding to each of the training images. And then, the M basic features and labeled image feature labels corresponding to respective training images are determined as training data to train the neural network model, such that the label generation model is obtained.

In an exemplary embodiment, the label generation model may be trained and generated by the following training method.

In detail, M basic features corresponding to a training image A1 may be inputted into a preset deep neural network model to generate a predicted image feature label B1. And then, on the basis of a difference between an image feature label B′ of the training image A1 that has been labeled and the predicted image feature label B1, a correction coefficient may be determined. According to the correction coefficient, the preset deep neural network model is corrected for the first time to generate a first label generation model.

After that, M basic features corresponding to a training image A2 may be inputted into the first label generation model to generate another predicted image feature label B2. On the basis of a difference between an image feature label B2′ of the training image A2 that has been labeled and the predicted image feature label B2, another correction coefficient may be determined to correct the first label generation model.

It may be understood that after determining the correction coefficient based on the M basic features corresponding to the training image A2, the image feature label B2′ of the training image A2 that has been labeled, and the predicted image feature label B2, a correction may be performed on the first label generation model. Since the training data includes M basic features corresponding to each of a plurality of images and image feature labels of the training images that have been labeled, the above process may be repeated. After a plurality of corrections, a first label generation model with good performance may be generated.

At block 104, an image description sentence of the target image is generated based on the M basic feature labels.

In detail, step 104 may be implemented in the following manner.

At block 104a, a category of an application is obtained.

It may be understood that the apparatus for describing the image in the present disclosure may be configured in an application, so that the application may use the image description sentence generated by the apparatus for describing the image to achieve certain functions. For example, suppose that a function to be implemented by an application C is to recognize a face in an image, and to recognize whether a text on the face in the image is an advertisement, the apparatus for describing the image may be configured in the application C, so that the application C may determine whether the image contains a human face and whether the human face contains an advertisement based on the image description sentence generated by the apparatus for describing the image.

Correspondingly, the apparatus for describing the image may generate the image description sentence of the target image in the following manner based on the category of the application configured in the apparatus.

At block 104b, a description model corresponding to the application is obtained based on the category of the application.

At block 104c, the M basic feature labels are inputted into the description model to generate the image description sentence of the target image.

In detail, applications may be divided into different categories based on functions realized by the applications, and description models corresponding to the applications of different categories may be set in advance, such that after the category of the application configured in the apparatus for describing the image is obtained, the M basic feature labels may be processed based on the description model corresponding to the category of the application so as to generate the image description sentence of the target image. Furthermore, the application may use the image description sentence of the target image to realize a corresponding function.

The description model may be any model that may process feature labels of an image, such as a neural network model including a convolutional neural network and a recurrent neural network, or other models. The description model is not limited in the present disclosure. The present disclosure takes the description model being a neural network model as an example for description.

In detail, when description models corresponding to different categories of applications are generated through training, image information required by each category of application for implementing a corresponding function may be determined first, and then an image recognition model that may recognize the image information may be used to recognize a plurality of images (the number of images may be set as needed) to generate a plurality of basic features corresponding to each image. A plurality of basic feature labels may be generated based on the plurality of basic features. For each image, an image description sentence that fully expresses the above image information in the image may be produced. The plurality of basic feature labels corresponding to each image and the image description sentence are determined as training data for training a description model corresponding to each category of application. And then, the training data of the description model corresponding to each category of application may be used to train the description model corresponding to the category of application. After a category of an application is obtained, a description model corresponding to the category of the application may be obtained. The M basic feature labels are inputted into the description model to generate the image description sentence of the target image, and the image description sentence may be used to implement a function realized by the program.

For example, suppose that among different categories of applications, an application of category A needs to use face information and facial expression information in an image to recognize whether someone is smiling in the image. Through the recognition of 1,000 images using the face recognition model, a facial expression feature that may express face information, such as the five sense organs and a contour of a face in each image, may be generated. A facial expression feature label may be generated based on each facial expression feature. For each image, an image description sentence, for example, “a laughing kid” and “a happy person”, that may fully express the face information and the facial expression information, such as a laughing or crying expression on a face, in the image may be produced and determined as training data for a description model corresponding to the application of category A. In other words, the training data includes the face feature label, the facial expression feature label, and the image description sentence corresponding to each of the 1,000 images. In this manner, the neural network model is trained using the training data to generate the description model corresponding to the application of category A. After the M basic feature labels are inputted into the description model corresponding to the application of category A, the image description sentence of the target image may be generated. The image description sentence may be used to recognize whether someone is smiling in the image.

In some embodiments, suppose that an application of category B needs to use the face information, skin color information and age information in the image to recognize whether there is an Asian child in the image. Through the recognition of 1,000 images using the face recognition model, a face feature that may express the face information, such as the five sense organs and the contour of a face in each image, may be generated. A face feature label may be generated based on the face feature. The skin color recognition model may be used to recognize the 1,000 images separately to generate a skin color feature that may express skin color information of a skin color in each image, and to generate a skin color feature label based on the skin color feature. The age recognition model may be adopted to recognize the 1,000 images to generate an age feature that may express age information in each image, and to generate an age feature label based on the age feature. For each image, an image description sentence that may fully express the face information, skin color information, and age information in the image, such as “a four- or five-year-old Asian child” and “an eighteen- or seventeen-year-old black-skinned person” may be produced and determined as training data of a description model corresponding to the application of category B. In other words, the training data includes the face feature label, the skin color feature label, the age feature label, and the image description sentence corresponding to each of the 1,000 images. In this manner, the neural network model is trained based on the training data to generate the description model corresponding to the application of category B. After the M basic feature labels are inputted into the description model corresponding to the application of category B, the image description sentence of the target image may be generated. The image description sentence may be used to recognize whether there is an Asian child in the image.

The following takes the training process of the description model corresponding to the application of category A as an example to illustrate the training process of the description model in the present disclosure.

In detail, the face feature label and the facial expression feature label corresponding to the image A1 may be inputted into the preset deep neural network model to generate a predicted image description sentence a1. And then, a correction coefficient may be determined based on a difference between an image description sentence a1′ that may fully express the face information and the facial expression information in the image A1 and the predicted image description sentence a1. The preset deep neural network model is corrected for the first time based on the correction coefficient to generate a first description model.

The face feature label and the facial expression feature label corresponding to the image A2 may be inputted into the first description model to generate a predicted image description sentence a2. And then, another correction coefficient may be determined based on a difference between an image description sentence a2′ that may fully express the face information and the facial expression information in the image A2 and the predicted image description sentence a2 to perform correction on the first description model.

It may be understood that after the correction coefficient is determined based on the face feature label, the facial expression feature label, the image description sentence a2′ that may fully express the face information and the facial expression information in an image, as well as the predicted image description sentence a2 of the image, the first description model may be corrected once. Since the training data includes face feature labels, facial expression feature labels, and image description sentences that may fully express face information and facial expression information in a plurality of images corresponding to the plurality of images, the above process may be repeated to perform a plurality of corrections, such that a description model with good performance may be generated.

The M basic feature labels may be inputted into the description model to generate the image description sentence of the target image.

For example, suppose that the application of category A needs to use the face information and the facial expression information in the image to recognize whether someone is smiling in the image. The target image may be processed with the N image recognition models and the label generation models to generate three basic feature labels, i.e., “a child”, “happy”, and “dog”, of the target image. The three basic feature labels may be inputted into the description model to generate the image description sentence “a happy child” of the target image.

It may be understood that the method for describing the image according to embodiments of the present disclosure may generate the image description sentence required by the application to realize its function by selecting a description template corresponding to the category of the application. In this manner, the image description sentence is more in line with needs of the application, so that the application may better use the image description sentence to achieve its function.

It should be noted that, in embodiments of the present disclosure, the application of category A is taken as an example. In addition to the face feature label, the facial expression feature label, the training data used to train the description model corresponding to the application of category A may also include basic feature labels obtained from other basic features generated after the training image is recognized by other image recognition models. Apart from fully expressing the face information and the facial expression information in the image, the image description sentence may also express other information in the image. Consequently, the image description sentence generated by inputting the M basic feature labels into the description model may not only fully express the image information required by the application of category A to realize its function, but also dig out other information in the image, such that the image description sentence is more expressive.

In addition, after the image description sentence of the target image is generated, the method for describing the image provided by the present disclosure may be used to further generate an image description sentence that may express more information based on the image description sentence generated and at least part of other basic feature labels, or based on a plurality of image description sentences. This iterative method may make information expressed by the image description sentence further meet needs of an application that implements more functions.

With the method for describing the image according to embodiments of the present disclosure, after the target image is acquired, the recognition is performed on the target image acquired through the plurality of image recognition models to generate the plurality of basic features. The plurality of basic feature labels are generated based on the plurality of basic features. The image description sentence of the target image is generated based on the plurality of basic feature labels. With the above method, the image description sentence generated is more expressive, information in the target image may be fully expressed, and the accuracy and reliability of the image description sentence are improved.

The method for describing the image according to embodiments of the present disclosure will be further described below.

FIG. 2 is a schematic diagram according to Embodiment 2 of the present disclosure.

As illustrated in FIG. 2, the method for describing the image provided by the present disclosure may include the following steps.

At block 201, a target image is acquired.

At block 202, recognition is performed on the target image through N image recognition models to generate M basic features of the target image.

N is a positive integer, and M is a positive integer less than or equal to N.

At block 203, M basic feature labels are generated based on the M basic features.

The specific implementation process and principles of steps 201-203 may be referred to the detailed description of the above embodiments, and thus will not be repeated here.

At block 204, a description template of the target image is obtained based on the category of the application.

At block 205, at least part of the M basic feature labels are inputted into the description template to form the image description sentence.

In detail, applications may be divided into different categories based on functions realized by the applications, and description templates corresponding to the applications of different categories may be set in advance, such that after a category of an application is obtained, the M basic feature labels may be processed based on the description template corresponding to the category of the application so as to generate the image description sentence of the target image. Furthermore, the application may use the image description sentence of the target image to realize a corresponding function.

In an exemplary embodiment, setting methods of description templates corresponding to different categories of applications may be different. The following is an example of setting methods of description templates.

Assume that the application of category A needs to use the face information and the facial expression information in the image to recognize whether someone is smiling in the image. A description template 1 corresponding to the application of category A may be “q s p”, where p corresponds to the facial expression feature label, s corresponds to the skin color feature label, and q corresponds to the face feature label. The image description sentence generated by the description template 1 includes the facial expression feature label, the face feature label and the skin color feature label, such that face information, facial expression information and skin color information of the target image may be fully presented.

In some embodiments, the description template 1 corresponding to the application of category A may also be “p r q” or “p q of r”, where p corresponds to the facial expression feature label, q corresponds to the face feature label, and r corresponds to the age feature label. The image description sentence generated in accordance with the description template 1 includes the facial expression feature label, the age feature label, and the face feature label. In addition to fully expressing the face information and the facial expression information of the target image, the image description sentence may also express age information. That is to say, the image description sentence generated by the description template corresponding to the application of category A may not only fully express the face information and the facial expression information that the application of category A needs to use, but also express some other related information, such as the skin color information or the age information, so that the image description sentence is more expressive.

For example, if the basic feature labels of the target image processed through the N image recognition models and the label generation models include “four- or five-year-old”, “happy”, and “child”, the three basic feature labels may be inputted into the description template 1 to form an image description sentence “a happy four- or five-year-old child”.

It is to be noted that the description template may be flexibly set with auxiliary words such as “of” and “in/on” as needed to make the image description sentence smooth and fluent.

In a specific implementation, the manner of selecting some of the M basic feature labels to be inputted into the description template to form the image description sentence may be implemented in the following way.

At block 205a, relevance among the M basic feature labels is obtained.

At block 205b, a first basic feature label and a second basic feature label relevant to the first basic feature label are obtained based on the relevance among the M basic feature labels.

At block 205c, the first basic feature label, the second basic feature label, and at least part of other basic feature labels than the first basic feature label and the second basic feature label are inputted into the description template to form the image description sentence.

In detail, it is possible to determine the relevance among the M basic feature labels and to obtain the first basic feature label and the second basic feature label relevant to the first basic feature label based on functions implemented by different categories of applications.

For example, suppose that the application of category A needs to use the face information and the facial expression information in the image, that is, the application of category A needs to use two image recognition models, the face recognition model and the facial expression recognition model, to recognize the target image. The image description sentence may be generated based on the face feature and the facial expression feature generated by the two models. It may be considered that among the M basic features, the relevance between the face feature label and the facial expression feature label is relatively high, so that the face feature label and the facial expression feature label with a relatively high relevance may be obtained. The face feature label, the facial expression feature label, and at least part of other basic feature labels than the face feature label and the facial expression feature label in the M basic feature labels are inputted into the description template to form the image description sentence.

The at least part of other basic feature labels than the face feature label and the facial expression feature label may be any one or more basic feature labels of low relevance to the first basic feature label and the second basic feature label, which is not limited in the present disclosure.

In detail, two thresholds, a first threshold and a second threshold, may be set. The first threshold is greater than the second threshold. Basic feature labels having relevance greater than the first threshold are considered to be of high relevance to each other, and basic feature labels having relevance greater than the second threshold and less than the first threshold are considered to be of low relevance to each other. Consequently, the relevance among the M basic feature labels may be obtained to determine the first basic feature label and the second basic feature label of high relevance to each other, as well as at least part of other basic feature labels than the first basic feature label and the second basic feature label of low relevance to each other. And then, the first basic feature label, the second basic feature label, as well as the at least part of other basic feature labels than the first basic feature label and the second basic feature label may be inputted into the description template to form the image description sentence.

Still, the application of category A is taken as an example. Suppose that after the target image is processed through the N image recognition models and the label generation models, five basic feature labels of the target image are generated, which are “four- or five-year-old”, “happy”, “child”, “advertisement”, and “grass”. The relevance among “four- or five-year-old”, “happy”, and “child” is greater than the first threshold, the relevance between “advertisement” and three basic feature labels, “four- or five-year-old”, “happy” as well as “child”, is less than the second threshold, and the relevance between “grass” and three basic feature labels, “four- or five-year-old”, “happy” as well as “child”, is greater than the second threshold and less than the first threshold, the four basic feature labels, “four- or five-year-old”, “happy”, “child”, and “grass”, may be inputted into the description template corresponding to the application of category A to form an image description sentence “there is a happy four- or five-year-old child on the grass.”

It should be noted that, in practical applications, there may be two or more basic feature labels relevant to each other in the M basic feature labels, and the present disclosure is not limited in this regard. The present disclosure only uses two basic feature labels, the first basic feature label and the second basic feature label, relevant to each other as an example.

With the method for describing the image, after the target image is acquired, the recognition is performed on the target image acquired through the plurality of image recognition models to generate the plurality of basic features. The plurality of basic feature labels are generated based on the plurality of basic features. The description template of the target image may be obtained based on the category of the application. The at least part of the M basic feature labels may be inputted into the description template to form the image description sentence. With the above method, the image description sentence generated is more expressive, information in the target image may be fully expressed, and the accuracy and reliability of the image description sentence are improved.

An apparatus for describing an image according to embodiments of the present disclosure will be described below with reference to the accompanying drawings.

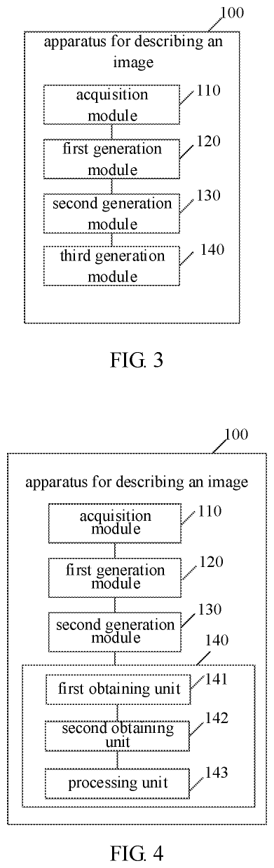

FIG. 3 is a schematic diagram according to Embodiment 3 of the present disclosure.

As illustrated in FIG. 3, an apparatus for describing an image 300 includes an acquisition module 110, a first generation module 120, a second generation module 130 and a third generation module 140.

The acquisition module 110 is configured to acquire a target image.

The first generation module 120 is configured to perform recognition on the target image through N image recognition models to generate M basic features of the target image. N is a positive integer, and M is a positive integer less than or equal to N.

The second generation module 130 is configured to generate M basic feature labels based on the M basic features.

The third generation module 140 is configured to generate an image description sentence of the target image based on the M basic feature labels.

In detail, the apparatus for describing the image according to embodiments of the present disclosure may implement the method for describing the image according to the foregoing embodiments of the present disclosure. The apparatus for describing the image may be configured in an electronic device to generate the image description sentence of the target image, such that the description of the image is realized. The electronic device may be any hardware device capable of data processing, such as a smart phone, a notebook computer, a wearable device, and so on.

In a possible implementation, the image recognition model includes more than one of a face recognition model, a text recognition model, a classification recognition model, a logo recognition model, a watermark recognition model, a dish recognition model, a license plate recognition model, a facial expression recognition model, an age recognition model, and a skin color recognition model.

It should be noted that, the implementation process and technical principles of the apparatus for describing the image according to the embodiment may be referred to the foregoing explanation of the method for describing the image according to embodiments of the first aspect, and thus will not be repeated here.

With the apparatus for describing the image according to embodiments of the present disclosure, after the target image is acquired, the recognition is performed on the target image acquired through the plurality of image recognition models to generate the plurality of basic features. The plurality of basic feature labels are generated based on the plurality of basic features. The image description sentence of the target image is generated based on the plurality of basic feature labels. With the above method, the image description sentence generated is more expressive, information in the target image may be fully expressed, and the accuracy and reliability of the image description sentence are improved.

FIG. 4 is a schematic diagram according to Embodiment 4 of the present disclosure.

As illustrated in FIG. 4, and on the basis of FIG. 3, in the apparatus for describing the image 100, the third generation module 140 includes a first obtaining unit 141, a second obtaining unit 142 and a processing unit 143.

The first obtaining unit 141 is configured to obtain a category of an application.

The second obtaining unit 142 is configured to obtain a description template of the target image based on the category of the application.

The processing unit 143 is configured to input at least part of the M basic feature labels into the description template to form the image description sentence.

In a possible implementation, the processing unit 143 is configured to: obtain relevance among the M basic feature labels; obtain a first basic feature label and a second basic feature label relevant to the first basic feature label based on the relevance among the M basic feature labels; and input into the description template with the first basic feature label, the second basic feature label, and at least part of other basic feature labels than the first basic feature label and the second basic feature label, to form the image description sentence.

In another possible implementation, the third generation module 140 is configured to: obtain a category of an application; obtain a description model corresponding to the application based on the category of the application; and input the M basic feature labels into the description model to generate the image description sentence of the target image.

It should be noted that, the implementation process and technical principles of the apparatus for describing the image according to the embodiment may be referred to the foregoing explanation of the method for describing the image according to embodiments of the first aspect, and thus will not be repeated here.

With the apparatus for describing the image according to embodiments of the present disclosure, after the target image is acquired, the recognition is performed on the target image acquired through the plurality of image recognition models to generate the plurality of basic features of the target image. The plurality of basic feature labels are generated based on the plurality of basic features. The image description sentence of the target image is generated based on the plurality of basic feature labels. With the above method, the image description sentence generated is more expressive, information in the target image may be fully expressed, and the accuracy and reliability of the image description sentence are improved.

According to embodiments of the present disclosure, an electronic device and a readable storage medium are provided.

FIG. 5 is a block diagram of an electronic device for implementing a method for describing an image according to embodiments of the present disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. Components shown herein, their connections and relationships as well as their functions are merely examples, and are not intended to limit the implementation of the present disclosure described and/or required herein.

As shown in FIG. 5, the electronic device includes: one or more processors 501, a memory 502, and interfaces for connecting various components, including a high-speed interface and a low-speed interface. The components are interconnected by different buses and may be mounted on a common motherboard or otherwise installed as required. The processor may process instructions executed within the electronic device, including instructions stored in or on the memory to display graphical information of the GUI on an external input/output device (such as a display device coupled to the interface). In other embodiments, when necessary, multiple processors and/or multiple buses may be used with multiple memories. Similarly, multiple electronic devices may be connected, each providing some of the necessary operations (for example, as a server array, a group of blade servers, or a multiprocessor system). One processor 501 is taken as an example in FIG. 5.

The memory 502 is a non-transitory computer-readable storage medium according to the embodiments of the present disclosure. The memory stores instructions executable by at least one processor, so that the at least one processor executes the method for describing the image provided by the present disclosure. The non-transitory computer-readable storage medium according to the present disclosure stores computer instructions, which are configured to make the computer execute the method for describing the image provided by the present disclosure.

As a non-transitory computer-readable storage medium, the memory 502 may be configured to store non-transitory software programs, non-transitory computer executable programs and modules, such as program instructions/modules corresponding to the method for describing the image according to embodiments of the present disclosure. The processor 501 executes various functional applications and performs data processing of the server by running non-transitory software programs, instructions and modules stored in the memory 502, that is, the method for describing the image according to the foregoing method embodiments is implemented.

The memory 502 may include a storage program area and a storage data area, where the storage program area may store an operating system and applications required for at least one function; and the storage data area may store data created according to the use of the electronic device that implements the method for describing the image according to the embodiments of the present disclosure, and the like. In addition, the memory 502 may include a high-speed random access memory, and may further include a non-transitory memory, such as at least one magnetic disk memory, a flash memory device, or other non-transitory solid-state memories. In some embodiments, the memory 502 may optionally include memories remotely disposed with respect to the processor 501, and these remote memories may be connected to the electronic device through a network. Examples of the network include, but are not limited to, the Internet, an intranet, a local area network, a mobile communication network, and combinations thereof.

The electronic device may further include an input device 503 and an output device 504. The processor 501, the memory 502, the input device 503 and the output device 504 may be connected through a bus or in other manners. FIG. 5 is illustrated by establishing the connection through a bus.

The input device 503 may receive input numeric or character information, and generate key signal inputs related to user settings and function control of the electronic device, such as a touch screen, a keypad, a mouse, a trackpad, a touchpad, a pointing stick, one or more mouse buttons, trackballs, joysticks and other input devices. The output device 504 may include a display device, an auxiliary lighting device (for example, an LED), a haptic feedback device (for example, a vibration motor), and so on. The display device may include, but is not limited to, a liquid crystal display (LCD), a light emitting diode (LED) display and a plasma display. In some embodiments, the display device may be a touch screen.

Various implementations of systems and technologies described herein may be implemented in digital electronic circuit systems, integrated circuit systems, application-specific ASICs (application-specific integrated circuits), computer hardware, firmware, software, and/or combinations thereof. These various implementations may include: being implemented in one or more computer programs that are executable and/or interpreted on a programmable system including at least one programmable processor. The programmable processor may be a dedicated or general-purpose programmable processor that may receive data and instructions from a storage system, at least one input device and at least one output device, and transmit the data and instructions to the storage system, the at least one input device and the at least one output device.

These computing programs (also known as programs, software, software applications, or codes) include machine instructions of a programmable processor, and may implement these calculation procedures by utilizing high-level procedures and/or object-oriented programming languages, and/or assembly/machine languages. As used herein, terms “machine-readable medium” and “computer-readable medium” refer to any computer program product, device and/or apparatus configured to provide machine instructions and/or data to a programmable processor (for example, a magnetic disk, an optical disk, a memory and a programmable logic device (PLD)), and includes machine-readable media that receive machine instructions as machine-readable signals. The term “machine-readable signals” refers to any signal used to provide machine instructions and/or data to a programmable processor.

In order to provide interactions with the user, the systems and technologies described herein may be implemented on a computer having: a display device (for example, a cathode ray tube (CRT) or a liquid crystal display (LCD) monitor) for displaying information to the user; and a keyboard and a pointing device (such as a mouse or trackball) through which the user may provide input to the computer. Other kinds of devices may also be used to provide interactions with the user; for example, the feedback provided to the user may be any form of sensory feedback (e.g., visual feedback, auditory feedback or haptic feedback); and input from the user may be received in any form (including acoustic input, voice input or tactile input).

The systems and technologies described herein may be implemented in a computing system that includes back-end components (for example, as a data server), a computing system that includes middleware components (for example, an application server), or a computing system that includes front-end components (for example, a user computer with a graphical user interface or a web browser, through which the user may interact with the implementation of the systems and technologies described herein), or a computing system including any combination of the back-end components, the middleware components or the front-end components. The components of the system may be interconnected by digital data communication (e.g., a communication network) in any form or medium. Examples of the communication network include: a local area network (LAN), a wide area network (WAN), and the Internet.

Computer systems may include a client and a server. The client and server are generally remote from each other and typically interact through the communication network. A client-server relationship is generated by computer programs running on respective computers and having a client-server relationship with each other.

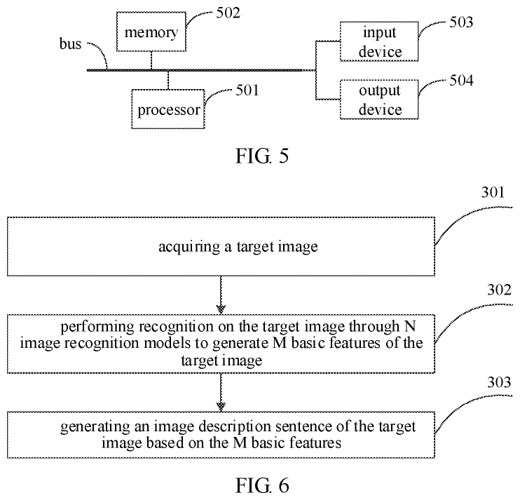

FIG. 6 is a schematic diagram according to Embodiment 5 of the present disclosure. In detail, the method for describing the image according to embodiments of the present disclosure may be implemented by the apparatus for describing the image according to embodiments of the present disclosure. The apparatus may be configured in an electronic device to generate an image description sentence of the target image, such that the description of the image is realized. The electronic device may be any hardware device capable of image processing, such as a smart phone, a notebook computer, a wearable device, and so on.

As illustrated in FIG. 6, the method for describing the image provided by the present disclosure may include the following steps.

At block 301, a target image is acquired.

The target image may be any type of image to be image processed, such as a static image, a dynamic image, and a frame of image in a video, which is not limited in the present disclosure.

At block 302, recognition is performed on the target image through N image recognition models to generate M basic features of the target image.

N is a positive integer, and M is a positive integer less than or equal to N.

In embodiments of the present disclosure, the image recognition model includes more than one of a face recognition model, a text recognition model, a classification recognition model, a logo recognition model, a watermark recognition model, a dish recognition model, a license plate recognition model, a facial expression recognition model, an age recognition model, and a skin color recognition model that implement different functions.

At block 303, an image description sentence of the target image is generated based on the M basic features.

It should be noted that the foregoing explanation of the method for describing the image is also applicable to the method for describing the image according to the embodiment. For related description, reference may be made to the relevant part, and steps are repeated here.

With the method for describing the image according to embodiments of the present disclosure, after the target image is acquired, the recognition is performed on the target image acquired through the plurality of image recognition models to generate the plurality of basic features of the target image. The image description sentence is generated based on the plurality of basic features. With the above method, the image description sentence generated is more expressive, information in the target image may be fully expressed, and the accuracy and reliability of the image description sentence are improved.

It should be understood that various forms of processes shown above may be reordered, added or deleted. For example, the blocks described in the present disclosure may be executed in parallel, sequentially, or in different orders. As long as the desired results of the technical solution disclosed in the present disclosure may be achieved, there is no limitation herein.

The foregoing specific implementations do not constitute a limit on the protection scope of the present disclosure. It should be understood by those skilled in the art that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for describing an image, comprising:
acquiring a target image;
performing recognition on the target image through N image recognition models to generate M basic features of the target image, N being a positive integer, and M being a positive integer less than or equal to N; and
generating an image description sentence of the target image based on the M basic features.

2. The method of claim 1, wherein generating the image description sentence of the target image based on the M basic feature labels comprises:
generating M basic feature labels based on the M basic features; and
generating the image description sentence based on the M basic feature labels.

3. The method of claim 2, wherein generating the image description sentence based on the M basic feature labels comprises:
obtaining a category of an application based on functions of the application;
obtaining a description template of the target image based on the category of the application; and
inputting at least part of the M basic feature labels into the description template to form the image description sentence.

4. The method of claim 3, wherein inputting the at least part of the M basic feature labels into the description template to form the image description sentence comprises:
obtaining relevance among the M basic feature labels;
obtaining a first basic feature label and a second basic feature label relevant to the first basic feature label based on the relevance among the M basic feature labels; and
inputting into the description template with the first basic feature label, the second basic feature label, and at least part of other basic feature labels than the first basic feature label and the second basic feature label, to form the image description sentence.

5. The method of claim 2, wherein generating the image description sentence based on the M basic feature labels comprises:
obtaining a category of an application;
obtaining a description model corresponding to the application based on the category of the application; and
inputting the M basic feature labels into the description model to generate the image description sentence of the target image.

6. The method of claim 1, wherein the image recognition model comprises more than one of a face recognition model, a text recognition model, a classification recognition model, a logo recognition model, a watermark recognition model, a dish recognition model, a license plate recognition model, a facial expression recognition model, an age recognition model, and a skin color recognition model.

7. The method of claim 4, wherein obtaining relevance among the M basic feature labels comprises:
obtaining the relevance among the M basic feature labels based on functions implemented by the application.

8. The method of claim 7, further comprising:
determining a relevance between two of M basic feature labels based on functions implemented by the application;
in response to determining that the relevance is greater than the first preset threshold, determining the two basic feature labels as the first basic feature label and the second basic feature label; and
in response to determining that the relevance is less than or equal to the first preset threshold and greater than a second preset threshold, determining the two basic feature labels as the other basic feature labels.

9. An electronic device, comprising:
at least one processor; and
a storage device communicatively connected to the at least one processor; wherein,
the storage device stores an instruction executable by the at least one processor, and when the instruction is executed by the at least one processor, the at least one processor is configured to:
acquire a target image;
perform recognition on the target image through N image recognition models to generate M basic features of the target image, N being a positive integer, and M being a positive integer less than or equal to N; and
generate an image description sentence of the target image based on the M basic features.

10. The electronic device of claim 9, wherein the at least one processor is further configured to:
generate M basic feature labels based on the M basic features; and
generate the image description sentence based on the M basic feature labels.

11. The electronic device of claim 10, wherein the at least one processor is further configured to:
obtain a category of an application based on functions of the application;
obtain a description template of the target image based on the category of the application; and
input at least part of the M basic feature labels into the description template to form the image description sentence.

12. The electronic device of claim 11, wherein the at least one processor is further configured to:
obtain relevance among the M basic feature labels;
obtain a first basic feature label and a second basic feature label relevant to the first basic feature label based on the relevance among the M basic feature labels; and
input into the description template with the first basic feature label, the second basic feature label, and at least part of other basic feature labels than the first basic feature label and the second basic feature label, to form the image description sentence.

13. The electronic device of claim 12, wherein the at least one processor is further configured to:
determine a relevance between two of M basic feature labels based on functions implemented by the application;
in response to determining that the relevance is greater than the first preset threshold, determine the two basic feature labels as the first basic feature label and the second basic feature label; and
in response to determining that the relevance is less than or equal to the first preset threshold and greater than a second preset threshold, determine the two basic feature labels as the other basic feature labels.

14. The electronic device of claim 10, wherein the at least one processor is further configured to:
obtain a category of an application;
obtain a description model corresponding to the application based on the category of the application; and
input the M basic feature labels into the description model to generate the image description sentence of the target image.

15. The electronic device of claim 9, wherein the image recognition model comprises more than one of a face recognition model, a text recognition model, a classification recognition model, a logo recognition model, a watermark recognition model, a dish recognition model, a license plate recognition model, a facial expression recognition model, an age recognition model, and a skin color recognition model.

16. A non-transitory computer-readable storage medium having a computer instruction stored thereon, wherein the computer instruction is configured to make a computer implement a method for describing an image, the method comprising:
acquiring a target image;
performing recognition on the target image through N image recognition models to generate M basic features of the target image, N being a positive integer, and M being a positive integer less than or equal to N; and
generating an image description sentence of the target image based on the M basic features.

17. The non-transitory computer-readable storage medium according to claim 16, wherein generating the image description sentence of the target image based on the M basic feature labels comprises:
generating M basic feature labels based on the M basic features; and
generating the image description sentence based on the M basic feature labels.

18. The non-transitory computer-readable storage medium according to claim 17, wherein generating the image description sentence based on the M basic feature labels comprises:
obtaining a category of an application based on functions of the application;
obtaining a description template of the target image based on the category of the application; and
inputting at least part of the M basic feature labels into the description template to form the image description sentence.

19. The non-transitory computer-readable storage medium according to claim 18, wherein inputting the at least part of the M basic feature labels into the description template to form the image description sentence comprises:
obtaining relevance among the M basic feature labels;
obtaining a first basic feature label and a second basic feature label relevant to the first basic feature label based on the relevance among the M basic feature labels; and
inputting into the description template with the first basic feature label, the second basic feature label, and at least part of other basic feature labels than the first basic feature label and the second basic feature label, to form the image description sentence.

20. The non-transitory computer-readable storage medium according to claim 16, wherein the image recognition model comprises more than one of a face recognition model, a text recognition model, a classification recognition model, a logo recognition model, a watermark recognition model, a dish recognition model, a license plate recognition model, a facial expression recognition model, an age recognition model, and a skin color recognition model.
